(19) United States
(12) Patent Application Publication
(10) Pub. No.: US 2008/0027943 A1
(43) Pub. Date: Jan. 31, 2008

(54) LOCATION-AWARE NETWORK ACCESS METHOD AND APPARATUS

(76) Inventor: Jonathan P. Clemens, DuPont, WA (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/461,313

(22) Filed: Jul. 31, 2006

(51) Int. Cl. G06F 17/30

(52) U.S. Cl. 707/10

(57) ABSTRACT

Methods, apparatuses, and systems associated with and/or having components capable of, location-based network access are disclosed herein.

### TECHNICAL FIELD

Embodiments of the invention relate generally to the field of internet working, specifically to methods, apparatuses, and systems associated with location-aware network access.

### BACKGROUND

Advances in processor, networking, communication and other related technologies have led to wide spread adoption of client/server networked computing, with client devices accessing network for a plethora of content. Client devices often may operate with individual user preferences, which may be incompatible with the security and other policies of an organization.

Proxy servers are sometimes used to allow one or more client devices to indirectly connect to a network. In these network schemes, a request for item(s) located on a network may be provided to a proxy server from a client device, and the proxy server may respond by retrieving the requested item(s) from the network and providing the requested item(s) to the client device. In some situations, a proxy server may instead respond by retrieving the requested item(s) from a cache and providing the requested item(s) to the client device.

In some contexts, an owner of a proxy server (e.g., an organization) may implement a control scheme to filter and/or monitor network access by one of more client devices. Such services may be user-specific according to an internet protocol address of a client device and/or a username/password authentication protocol. Generally, such a control scheme may be implemented by filtering and/or monitoring content at the proxy server level. That is, a request provided to the proxy server from a recognized client device may be filtered and/or monitored at the proxy server. More specifically, if the request is for restricted content, the request may never be sent out to the network.

To complicate matters, organizations having a multi-national presence may be subject to laws of a location in which a proxy server and/or the organization is located. Such laws may provide for more restrictive network access than the organization otherwise chooses to implement and/or may provide that content may not be monitored. Given vast differences among countries/jurisdictions, a multi-national organization may be at risk of violating such laws. Unfortunately, an organization in such a position may be forced to adopt the most stringent legal policies among the relevant jurisdictions which may be far more restrictive than necessary and/or desired in those countries having less stringent laws.

### BRIEF DESCRIPTION OF THE DRAWINGS

Embodiments of the present invention will be readily understood by the following detailed description in conjunction with the accompanying drawings. Embodiments of the invention are illustrated by way of example and not by way of limitation in the figures of the accompanying drawings.

FIG. 1 illustrates an overview of embodiments of the present invention;

FIG. 2 illustrates a method incorporated with the teachings of the present invention, in accordance with various embodiments;

FIG. 3 illustrates an apparatus incorporated with the teachings of the present invention, in accordance with various embodiments; and

FIG. 4 illustrates a system incorporated with the teachings of the present invention, in accordance with various embodiments;

### DETAILED DESCRIPTION OF EMBODIMENTS OF THE INVENTION

In the following detailed description, reference is made to the accompanying drawings which form a part hereof and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).” The phrase “(A) B” means “(B) or (A B),” that is, A is optional.

In embodiments of the present invention, methods, apparatuses, articles of manufacture, and systems for location-aware network access are provided. In exemplary embodiments of the present invention, a computing system may be endowed with one or more components of the disclosed articles of manufacture and systems and may be employed to perform one or more methods as disclosed herein.

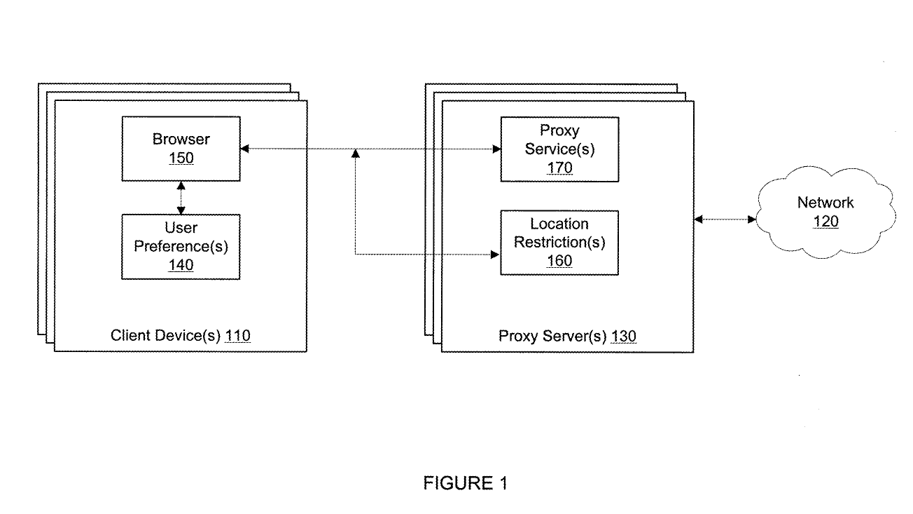

Referring now to FIG. 1, illustrated is an overview of various embodiments of the present invention. For the embodiments and as shown, one or more client devices 110 may be connected with a network 120 via one or more proxy servers 130. In various ones of the embodiments, client device 110 may comprise one or more user preferences 140 and a browser 150, while proxy server(s) 130 may comprise one or more location restrictions 160 and one or more proxy service instructions 170. In embodiments, client device 110 may be adapted to receive or retrieve one or more of location restriction(s) 160 and access network 120 based at least in part on one or more of the user preference(s) 140 subject to location restriction(s) 160.

User preference(s) 140 may comprise preference(s) and/or restriction(s) based at least in part an identity of a user. In various embodiments, user preference(s) 140 may be based on an internet protocol (IP) address of a client device, a username, or any other identifying factors for a user and/or a client device 110. In various embodiments, user preference(s) 140 may be received or retrieved from a server based at least in part on one or more identifying factors. However, in various other embodiments, user preference(s) 140 may be located on client device 110 upon a user's accessing of client device 110. User preference(s) 140 may govern, among other things, network accesses of client devices 110, in particular, the operation of browser 150.

Location restriction(s) 160 may comprise preference(s) and/or restriction(s) based at least in part a location of one or more of various components of embodiments of the present invention. In various embodiments, location restriction(s) 160 may be based at least in part on a location of a selected one or more of client device 110, a user of client device 110, and proxy server 130. “Location” may refer to a selected one or more of a geographic location of one or more components of embodiments of the present invention, a citizenship of a user of client device 110, and a network account (e.g., local or remote network accessing). A “geographic location” may be a political entity (e.g., a country, a county, a city, etc.), a building or group of buildings, a part of a building, or some other spatial reference. A “location” may be determined using one of various protocols including, for example, an IP address, a username, and various authentication protocols.

Location restriction(s) 160 may sometimes include one or more restrictions imposed by a law or other restriction of a location. For example, in some countries, visiting certain types of internet sites may be restricted. In some countries, privacy laws prevent monitoring, restricting, and/or collecting data on a user's network access.

One or more client devices 110 may comprise one or more user preferences 140 and may be adapted to receive or retrieve one or more location restriction(s) 160 and access network 120 based at least in part on one or more of user preference(s) 140 subject to location restriction(s) 160. For example, user preferences 140 may be analyzed to determine whether the user preference(s) 140 should be accommodated in view of location restriction(s) 160. In various embodiments, analysis of user preference(s) 140 may comprise a comparison of a user rule to a location rule. In some embodiments, access to a network may be facilitated based at least in part on a location rule if a user rule conflicts with the location rule.

For example, if a user rule comprises a rule “user may access internet sites of type A” and a location rule comprises a rule “user may not access internet sites of type A,” then a conflict may exist. In the example, access to network 120 may be facilitated based at least in part on the location rule because the user rule conflicts with the location rule. In various embodiments, if the user attempts to access internet sites of type A, the user may receive an indication of the restriction (e.g., an error message may be displayed or otherwise indicated). If the location rule is based on a law of the location, then the facilitation of access to network 120 based at least in part on the location rule may ensure compliance with the law of the location. However, in various other exemplary situations, access to network 120 may be facilitated at least in part on the user rule. For example, if a user rule is more restrictive than a location rule yet not illegal, then the user preference may be honored, depending on the applications.

In various embodiments, one or more user preferences 140 may be modified based at least in part on one or more location restrictions 160. For example, client device 110 may include one or more user preferences 140, receive or retrieve one or more location restrictions 160, and modify one or more of the user preferences 140 based at least in part on one or more of the location restrictions 160. In various embodiments, facilitation of access to network 120 by a user may be based at least in part on a modified user preference. In various embodiments and depending on the applications, a modified user preference may form a resultant user preference by which a user's access to a network may be facilitated (i.e., the unmodified user preference remains static yet a new user preference is created). However, in various embodiments, the user preference itself may be modified.

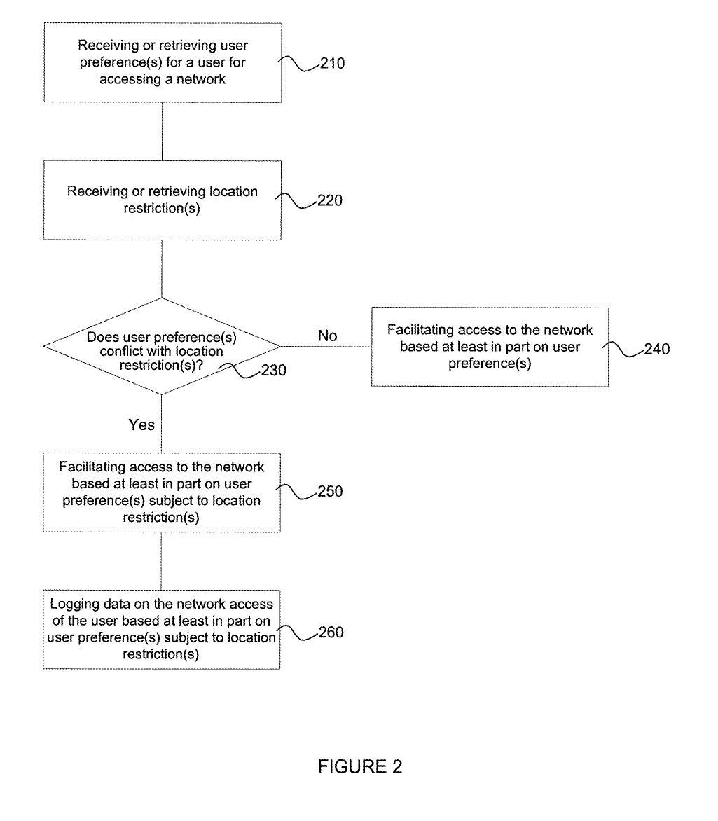

FIG. 2 illustrates an embodiment of a method incorporating various features and methods previously discussed. As shown, the exemplary method may comprise receiving or retrieving user preference(s) for a user for accessing a network (shown at 210), and receiving or retrieving location restriction(s) for a location (shown at 220). In accordance with various embodiments, user preference(s) and location restriction(s) may be analyzed to determine if the user preference(s) conflict with the location restriction(s) (shown at 230). If no conflict exists, access to a network may be facilitating based at least in part on user preference(s) (shown at 240). However, if one or more user preferences conflict with one or more location restrictions, access to a network may be facilitated based at least in part on user preference(s) subject to location restriction(s) (shown at 250). In various embodiments, operations 210-250 are all performed on client devices 110. In alternate embodiments, one or more of operations 210-250 may be performed on proxy server 130. Still further, in various embodiments, one or more of operations 210-250 may be repeated for one or more additional user preferences and/or location restrictions. In various ones of these embodiments, repeated operations may form a resultant user preference set, which may replace the user preferences or may form an additional user preference set, and a user's access to a network may be facilitated based at least in part on the resultant user preference set.

In various embodiments, data may be collected on a network access. A network access of a user may include internet site(s) visited, amount of time accessing a network, amount of time accessing internet site(s), type(s) of internet site(s) visited, etc. In various ones of these embodiments, logs of data on a network access may stored. For example, a log of data on a network access may be stored on a storage device, and in some embodiments, the storage device may included in a client device and/or a server (e.g., a main server, a proxy server, etc.). Depending on the applications, a report may be generated indicating part or all of data logged on a network access.

In various embodiments, data of a network access may be logged based at least in part on one or more user preference(s) subject to one or more location restriction(s). For example, user preference(s) and/or location restriction(s) may include preference(s) and/or restriction(s) indicating whether data of a network access may or is desired to be logged. In embodiments, if a user preference and a location restriction conflict, data may be logged based at least in part of the user preference subject to the location restriction. For example, in various embodiments, if a user preference indicates “log data” for a network access, yet a location restriction indicates “do not log data,” a network access may be facilitated without logging data thereof.

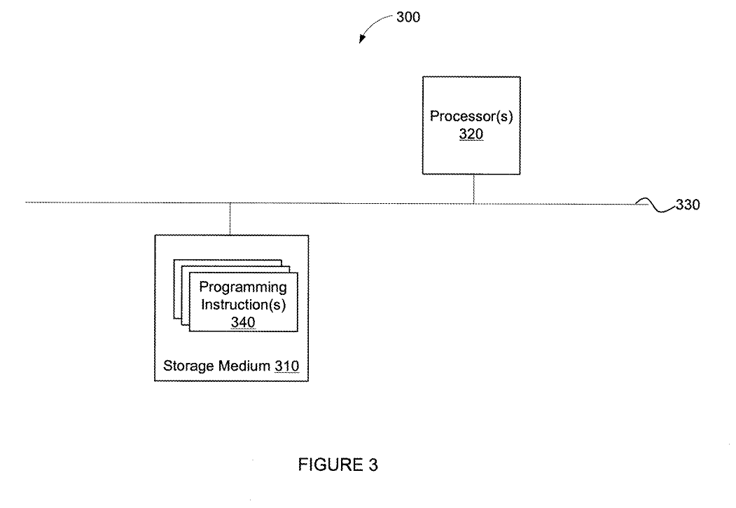

In exemplary embodiments of the present invention, an apparatus may be employed to perform one or more methods as disclosed herein. For example, an exemplary embodiment of an apparatus is illustrated in FIG. 3. In embodiments and as shown, apparatus 300 may comprise storage medium 310 and processor(s) 320 coupled with storage medium 310. Storage medium 310 may take a variety of forms including, but not limited to, volatile and persistent memory, such as, but not limited to, compact disc read-only memory (CD-ROM) and flash memory. In various ones of these embodiments, storage medium 310 and processor(s) 320 may be coupled via bus 330. A plurality of programming instructions 340 may be stored in storage medium 310 and may be designed to facilitate one or more methods as disclosed herein. For example, in various embodiments, programming instructions 340 may be designed to facilitate receipt or retrieval of user preference(s) and location restriction(s), and further designed to facilitate access to a network based at least in part on user preference(s) subject to location restriction(s). In various embodiments, apparatus 300 may be a client device.

In embodiments of the present invention, an article of manufacture may be employed to implement one or more methods as disclosed herein. For example, in exemplary embodiments, an article of manufacture may comprise a storage medium and a plurality of programming instructions stored in the storage medium and adapted to program an apparatus to enable the apparatus to request from a proxy server one or more location restriction(s) to modify one or more user preference(s). In various ones of these embodiments, programming instructions may be adapted to modify one or more user preferences to subject the one or more user preferences to one or more location restrictions. In various embodiments, article of manufacture may be employed to implement one or more methods as disclosed herein in one or more client devices. In various embodiments, programming instructions may be adapted to implement a browser, and in various ones of these embodiments, a browser may be adapted to allow a user to display information related to a network access. In an exemplary embodiment, programming instructions may be adapted to implement a browser on a client device.

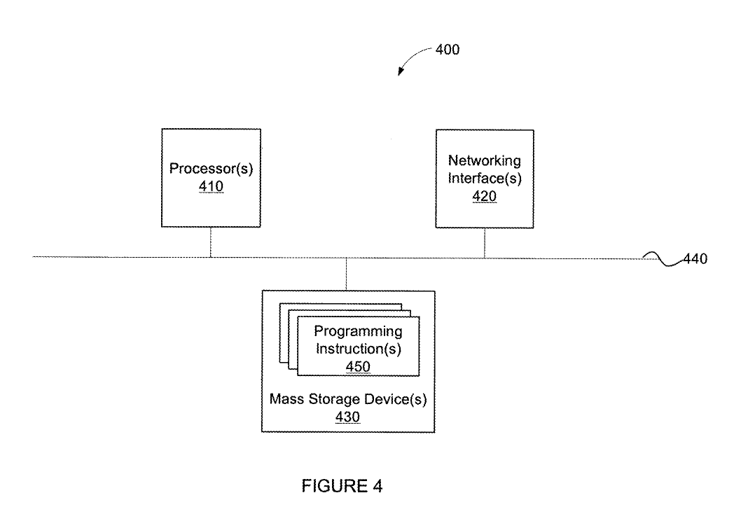

In embodiments of the present invention, a system may be employed to to perform one or more methods as disclosed herein. For example, an exemplary embodiment of a system is illustrated in FIG. 4. In embodiments and as shown, system 400 may comprise one or more processors 410, one or more networking interfaces 420, and one or more mass storage devices 430, coupled with each other via bus 440. In various ones of these embodiments, a plurality of programming instructions 450 may be stored in mass storage device(s) 430 to be executed by processor(s) 410, and may be adapted to enable system 400 perform one or more methods as disclosed herein. Mass storage device(s) 430 may take a variety of forms including, but are not limited to, a hard disk drive, a compact disc (CD) drive, a digital versatile disc (DVD) drive, a floppy diskette, a tape system, and so forth. In particular, mass storage device(s) 430 include programming instructions implementing all or selected aspects of the earlier-described embodiments of methods of the invention. In various embodiments, system 400 may be a proxy server implementing all or selected aspects of the earlier-described embodiments of methods of the invention.

In various embodiments, system 400 may be a fully integrated unit or may comprise a number of separate components that may be coupled or otherwise associated with each other. Furthermore, in embodiments endowed with a user interface, the user interface may comprise any one or more various software programs to aid in one or more of data acquisition, data storage, operation and/or control, and/or other various functions.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A method, comprising:
receiving or retrieving by a computing apparatus one or more user preferences for a user for accessing a network;
receiving or retrieving by the computing apparatus one or more location restrictions for a location; and
facilitating the user, by the computing apparatus, access to the network based at least in part on the one or more user preferences subject to the one or more location restrictions.

2. The method of claim 1, wherein said facilitating comprises analyzing by the computing apparatus a user preference to determine whether the user preference should be accommodated in view of the location restriction(s).

3. The method of claim 2, wherein said analyzing comprises comparing a user rule to a location rule, and said facilitating comprises facilitating access to the network based at least in part on the location rule if the user rule conflicts with the location rule.

4. The method of claim 1, further comprising logging by the computing apparatus data on a network access of the user based at least in part on the one or more user preferences subject to the one or more location restrictions.

5. The method of claim 4, further comprising generating by the computing apparatus a report of the logged data.

6. The method of claim 1, wherein the receiving or retrieving by the computing apparatus the one or more location restrictions comprises receiving or retrieving by the computing apparatus the one or more location restrictions based at least in part on a selected one or more of a geographic location of the user, a citizenship of the user, a network account of the user, and a geographic location of a server.

7. The method of claim 1, wherein the receiving or retrieving by the computing apparatus the one or more location restrictions comprises receiving or retrieving by the computing apparatus the one or more location restrictions based at least in part on one or more laws of the location.

8. The method of claim 1, wherein the receiving or retrieving by the computing apparatus the one or more location restrictions comprises receiving or retrieving by the computing apparatus the one or more location restrictions based at least in part on an internet protocol address of the user.

9. The method of claim 1, wherein the receiving or retrieving by the computing apparatus the one or more user preferences comprises receiving or retrieving by the computing apparatus the one or more user preferences based at least in part on an internet protocol address of the user.

10. An apparatus, comprising:
storage medium having stored therein a plurality of programming instructions designed to facilitate:
receipt or retrieval of one or more user preferences of a user for accessing a network;
receipt or retrieval of one or more location restrictions for a location; and
access to the network by the user based at least in part on the one or more user preferences subject to the one or more location restrictions;
at least one processor coupled with the storage medium to execute the programming instructions.

11. The apparatus of claim 10, wherein the plurality of programming instructions are designed to facilitate access to the network by analyzing a user preference to determine whether the user preference should be accommodated in view of the location restriction(s).

12. The apparatus of claim 11, wherein the plurality of programming instructions are designed to analyze the user preference by comparing a user rule to a location rule, and wherein the plurality of programming instructions are further adapted to program the apparatus to modify the user preference based at least in part on the location rule if the user rule conflicts with the location rule.

13. The apparatus of claim 12, wherein the plurality of programming instructions are designed to facilitate access to the network by facilitating access to the network based at least in part on the modified user preference.

14. The apparatus of claim 10, wherein the plurality of programming instructions are further designed to facilitate logging of data on a network access of the user based at least in part on the one or more user preferences subject to the one or more location restrictions.

15. An article of manufacture, comprising:
a storage medium; and
a plurality of programming instructions stored in the storage medium adapted to program an apparatus to enable the apparatus to:
request from a proxy server one or more location restrictions of a location to modify one or more user preferences of the apparatus for facilitating a user to access a network;
receive the one or more location restrictions for the location from the proxy server; and
modifying the one or more user preferences to subject the one or more
user preferences to the one or more location restrictions.

16. The article of manufacture of claim 15, wherein the plurality of programming instructions are adapted to analyze a user preference to determine whether the user preference should be accommodated in view of the location restriction(s).

17. The article of manufacture of claim 16, wherein the plurality of programming instructions are adapted to analyze the user preference by comparing a user rule to a location rule, and to modify the user preference based at least in part on the location rule if the user rule conflicts with the location rule.

18. The article of manufacture of claim 17, wherein the plurality of programming instructions are further adapted to implement a browser.

19. A system, comprising:
one or more processors;
one or more networking interfaces coupled with the one or more processors; and
one or more mass storage devices coupled with the one or more processors, and having programming instructions to be executed by the processor(s) and adapted to enable the system to:
receive a request from a client device for one or more location restrictions for a location, for use to modify one or more user preferences of the client device for accessing a network;
provide the client device, in response to the request, the one or more location restrictions; and
facilitate access to the network by the client device, for a user, based at least in part on the user preferences modified by the one or more location restrictions.

20. The system of claim 19, wherein the programming instructions are further adapted to enable the system to log data on a network access of the client device, for a user, based at least in part on the user preferences modified by the one or more location restrictions.

21. The system of claim 19, wherein the system is a proxy server.
